(19) United States
(12) Patent Application Publication
(10) Pub. No.: US 2019/0272569 A1
(43) Pub. Date: Sep. 5, 2019

(54) Machine Tool Management System

(71) Applicant: DMG MORI CO., LTD., Nara (JP)

(72) Inventor: Masao Kanamoto, Nara (JP)

(73) Assignee: DMG MORI CO., LTD., Nara (JP)

(21) Appl. No.: 16/344,277

(22) PCT Filed: Oct. 17, 2017
(86) PCT No.: PCT/JP2017/037471

§ 371 Date: Apr. 23, 2019

(30) Foreign Application Priority Data
Nov. 15, 2016 (JP) 2016-222093

(51) Int. Cl. G06Q 30/02; G05B 19/4063

(52) U.S. Cl. CPC G06Q 30/0283; G05B 2219/31408; G05B 19/4063

(57) ABSTRACT

Provided is a management system (1) which allows a machine tool (101) to be installed in any region and which can charge a use fee corresponding to usage of the machine tool (101) efficiently. The management system (1) includes at least one machine tool (101) having attached thereto a use monitoring device (110) having a communication function for connecting to Internet (2), and disposed at a location available to a specified or unspecified user, and a management device (10) connecting to the Internet (2) and communicating with the use monitoring device (110). The use monitoring device (110) transmits information on usage of the machine tool (101) to the management device (10), and the management device (10) calculates, as a use fee, a cost corresponding to the usage of the machine tool (101) received from the use monitoring device (110), and then executes a processing of charging the calculated use fee to the user.

### TECHNICAL FIELD

The present invention relates to a machine tool management system which manages, through the Internet, at least one machine tool disposed at a location available to a specified or unspecified user.

### BACKGROUND ART

Various systems connecting a machine tool disposed at a production site to a management device through the Internet have been known. The applicant has already provided a maintenance management system that connects at least one user's management device disposed on the user's side to a manufacturer's management device disposed on the machine tool manufacturer's side, through the Internet.

In this maintenance management system, the user's management device is connected to a numerical control part (controller) of at least one machine tool, the machine tool including a drive mechanism unit and the numerical control part that controls operation of the drive mechanism unit.

The user's management device includes user-side operational data storing means and data transmitting means, the use-side operational data storing means storing data on an operational status of the drive mechanism unit of the machine tool, the data transmitting means collecting data on the operational status of the drive mechanism unit from the numerical control part, accumulating the data in the user-side operational data storing means, checking whether predetermined transmission conditions are satisfied, and, only when the transmission conditions are satisfied, transmitting the operational status data of the drive mechanism unit accumulated in the use-side operational data storing means to the manufacturer's management device in an email form.

On the other hand, the manufacturer's management device includes a manufacturer-side operational data storing means, data receiving means, consumption degree data storing means, consumption degree evaluating means, and alarm outputting means, the manufacturer-side operational data storing means storing the operational status data of the drive mechanism unit received from the user's management device, the data receiving means receiving the operational status data of the drive mechanism unit transmitted from the user's management device and updating the operational status data stored in the manufacturer-side operational data storing means with the received operational status data, the consumption degree data storing means storing data on a degree of consumption of the drive mechanism unit, the consumption degree evaluating means occasionally evaluating the degree of consumption of the drive mechanism unit based on the operational status data of the drive mechanism unit stored in the manufacturer-side operational data storing means and updating the consumption degree data stored in the consumption degree data storing means with the evaluated consumption degree data, and the alarm outputting means occasionally monitoring whether the consumption degree data stored in the consumption degree data storing means exceeds a predetermined reference value, and when the data exceeds the reference value, outputting an alarm providing a notice of the exceeding.

In this maintenance management system, first, the data transmitting means of the user's management device collects data on an operational status (operational status data) of the drive mechanism unit from the numerical control part of the machine tool, and the collected data is accumulated in the user-side operational data storing means. It is occasionally checked whether predetermined transmission conditions are satisfied, and only when the transmission conditions are satisfied, the operational status data of the drive mechanism unit accumulated in the user-side operational data storing means is transmitted to the manufacturer's management device in an email form.

The transmitted operational status data is received by the data receiving means, and the operational status data of the drive mechanism unit stored in the manufacturer-side operational data storing means is updated with the received operational status data. Further, the consumption degree evaluating means occasionally evaluates the degree of consumption of the drive mechanism unit based on the operational status data of the drive mechanism unit stored in the manufacturer-side operational data storing means, and updates the consumption degree data stored in the consumption degree data storing means with the evaluated consumption degree data. Further, the alarm outputting means occasionally monitors whether the consumption degree data stored in the consumption degree data storing means exceeds a predetermined reference value, and, upon confirming that the data exceeds the reference value, outputs an alarm providing a notice of the exceeding.

Thus, this maintenance management system is configured such that the degree of consumption of the drive mechanism unit of the machine tool is occasionally evaluated and monitored, and when the degree of consumption exceeds a predetermined reference value, that is, when a consumable part of the drive mechanism unit approaches the end of its life, an alarm is output. Therefore, the manufacturer can easily recognize a consumable part approaching the end of its life based on the output alarm, which enables the manufacturer to predict when, how many, and which consumable part is needed. Consequently, the manufacturer does not have to excessively keep socks of consumable parts and therefore can greatly reduce the stocks of the consumable parts.

### CITATION LIST

### Patent Literature

Patent Literature 1: Japanese Unexamined Patent Application Publication No. 2004-295348

### SUMMARY OF INVENTION

### Technical Problem

In recent years, in the field of machine tools, a combined machining lathe which has lathe elements as a basic structure but is adapted to be capable of milling, and highly functional machine tools, such as a machining center capable of 5-axis machining, which are able to perform advanced and complicated machining have been provided. Further, there are machine tools including an automatic tool changer (ATC), an automatic pallet changer (APC), a tool measurement system, or a workpiece measuring system; that is to say, a wide variety of machine tools have been provided. Furthermore, peripheral devices for the purpose of automation, such as a robot and a loader for loading and attachment/removal of a workpiece, also have been provided.

Such highly functional machine tools are, of course, very expensive as compared with general-purpose machine tools, and when their peripheral device is included, they require a considerable amount of capital expenditure. Therefore, when a user is considering introduction of a machine tool, if the user can obtain an amount of work which achieves a profitable availability of the machine tool or the user can predict such an amount of work, the user can proceed with introduction of the machine tool; however, if not, the user has to refrain from capital expenditure.

However, in recent years, uncertainty of the global economy has been increased; currently, many companies cannot accurately predict demand, and therefore they cannot make an aggressive capital expenditure. In particular, capital expenditure imposes a heavy burden on small and medium-sized companies. Therefore, demand for machine tool manufacturers is not stable and the demand is constantly subject to large fluctuation.

Simultaneously, some companies have potential demand, e.g., there is a case where a company, which does not have an amount of work which sufficiently matches capital expenditure, has to give up receiving orders because their existing equipment is not capable of handling the orders. Further, there is also a case where a company puts off replacement of their equipment even though it is time to replace, because they cannot accurately predict demand.

Accordingly, in such cases, charging a user a use fee according to usage of a machine tool, instead of selling a machine tool, will allow the user to avoid a risk of excessive capital expenditure. Further, it is very beneficial because the user only has to bear equipment costs determined by actual use of the machine tool.

On the other hand, machine tool manufacturers have a problem that, when demand is unstable, they cannot perform a stable and levelled production; therefore, loss is produced in their production plan including personnel positioning and parts procurement, and such loss leads to increase in production costs. However, accommodating potential demand users have and facilitating replacement of equipment will make demand for machine tools relatively more stable. Such stabilization of demand will provide machine tool manufacturers with an advantage that they can realize a stable planed production that facilitates obtaining profits.

Thus, recently, in the field of machine tools, development of a system is desired which does not necessitate selling a machine tool but can charge a user a use fee corresponding to usage of the machine tool so as to dig up potential demand the user have and so as to promote replacement of equipment. Additionally, development of a system is desired which allows the machine tool to be installed in any region and can be operated efficiently.

Since such a system needs to satisfy the condition that the machine tool can be installed in any region, and needs to execute its processings efficiently, it is preferable that such a system is a system using the Internet.

The present invention has been achieved in view of the above-described circumstances, and an object thereof is to provide a machine tool management system which allows a machine tool to be installed in any region and can charge a user a use fee corresponding to usage of the machine tool efficiently.

### Solution to Problem

The present invention, for solving the above-described problems, relates to a machine tool management system including:

at least one machine tool having attached thereto a use monitoring device having a communication function for connecting to Internet, the machine tool being disposed at a location available to a specified or unspecified user; and

a management device connecting to the Internet and communicating with the use monitoring device,

the use monitoring device being configured to transmit information on usage of the machine tool to the management device; and

the management device being configured to calculate, as a use fee, a cost corresponding to the usage of the machine tool received from the use monitoring device, and then execute a processing of charging the calculated use fee to the user.

In this machine tool management system, the at least one machine tool is disposed at a location available to a specified or unspecified user. In the case of a machine tool being used by a specified user, for example, the machine tool is disposed in a plant owned by the user. In contrast, in the case of a machine tool being used by an unspecified user, for example, the machine tool is disposed in a building arranged by the machine tool manufacturer.

The machine tool has a use monitoring device attached thereto, the use monitoring device being connected to the Internet and being able to communicate with the management device that is also connected to the Internet. The management device is under management by the machine tool manufacturer; however, the management device can be installed at any location.

When the machine tool disposed is used by a specified or unspecified user, the use monitoring device attached to the machine tool transmits information on usage of the machine tool to the management device. The information on the usage of the machine tool forms the basis of calculation for charging the user a commensurate cost for the use of the machine tool. For example, the information includes an operating time of the machine tool.

The management device calculates, as a use fee, a cost corresponding to the usage of the machine tool received from the use monitoring device and executes a processing of charging the calculated use fee to the user.

As described above, with the machine tool management system according to the present invention, the user does not have to purchase the machine tool and can perform necessary machining only by paying a use fee corresponding to usage of the machine tool. Therefore, even in the case where the amount of work the user has is not so large as to cause the machine tool to run at full capacity, the user can perform machining corresponding to the amount of work without installing a new machine tool; therefore, the user can accommodate demand. Further, paying a use fee corresponding to usage of the machine tool as described above allows the user to replace the existing machine tool with a state-of-the-art machine tool without making capital expenditure. Therefore, replacement of equipment is promoted even in the case where the user does not have stable demand or even in the case where there is a risk such as sudden fluctuation in demand.

On the other hand, since new demand is generated which does not require capital expenditure, the machine tool manufacturer can realize a stable planned production that facilitates obtaining profits. Further, since the management system is a system using the Internet, the machine tool can be installed in any region. For example, the machine tool can be installed abroad, and, even in such a case where the machine tool is installed abroad, the charging processing can be executed efficiently.

In the present invention, it is preferable that the management device is configured to make settlement of the use fee charged to the user, by executing a processing in cooperation with the use monitoring device. Such cooperative settlement means electronic settlement through the Internet, where the user uses the use monitoring device to make settlement of the cost charged to the user by the management device. Examples of the cooperative settlement include settlement by a credit card and settlement by automatic withdrawal from the user's bank account.

Further, in the present invention, it is preferable that:

the use monitoring device is configured to execute a processing of registering the user in the management device; and

the management device is configured to execute a processing of transmitting identification information for the registered user to the use monitoring device.

With this configuration, it is possible to identify a user who uses the machine tool management system, and the charging processing can be executed with high reliability for a user who has been registered and assigned identification information. Further, it is possible to accumulate information, such as usage history, on the user; making good use of such accumulated information enables prediction of the user's order-receiving trends and future capital expenditure.

In the present invention, the machine tool may have provided therein associated facility and function to be used in machining performed with the machine tool, and

the use monitoring device may be configured to transmit the information on the usage of the machine tool inclusive of information on usage of the associated facility and function to the management device.

The associated facility and function include, for example, an automatic programming apparatus, an interactive programming apparatus, a special cycle function, a tool measurement system, and a workpiece measurement system. In some machining operations, the user wants to use such an associated facility or such an associated function. With this configuration, the user can use the associated facility and function as necessary, and the machine tool manufacturer can charge the user a cost corresponding to usage of the associated facility and function.

In the present invention, the machine tool may include a turning mechanism as a basic mechanism and include, as an additional mechanism, one or more mechanisms selected from among a tailstock mechanism, a steady rest mechanism, a milling mechanism, second and subsequent tool rests, second and subsequent spindle mechanisms, and a coolant mechanism; and

the use monitoring device may be configured to transmit the information on the usage of the machine tool inclusive of information on usage of the additional mechanism to the management device.

In some machining operations, the user wants to use the additional mechanism in addition to the turning mechanism that is the basic mechanism. With this configuration, the user can use the additional mechanism as necessary, and the machine tool manufacturer can charge the user a cost corresponding to usage of the additional mechanism.

In the present invention, the machine tool may include a milling mechanism as a basic mechanism and include, as an additional mechanism, one or more mechanisms selected from among a rotating shaft other than a tool spindle, a mechanism associated with a U-shaft of the tool spindle, a workpiece clamping mechanism, and a coolant mechanism; and

the use monitoring device may be configured to transmit the information on the usage of the machine tool inclusive of information on usage of the additional mechanism to the management device.

In some machining operations, the user wants to use the additional mechanism in addition to the milling mechanism that is the basic mechanism. With this configuration, the user can use the additional mechanism as necessary, and the machine tool manufacturer can charge the user a cost corresponding to usage of the additional mechanism.

In the present invention, the machine tool may include a main mechanism performing machining, and a peripheral mechanism provided around the main mechanism; and

the use monitoring device may be configured to transmit the information on the usage of the machine tool inclusive of information on usage of the peripheral mechanism to the management device.

The peripheral mechanism includes, for example, a robot and a workpiece loading/unloading apparatus. In some machining operations, the user wants to use the peripheral mechanism in addition to the main mechanism. With this configuration, the user can use the peripheral mechanism as necessary, and the machine tool manufacturer can charge the user a cost corresponding to usage of the peripheral mechanism. Note that the main mechanism, as used herein, has a concept including the basic mechanism and the additional mechanism.

In the present invention, an accessory instrument to be used in machining performed with the machine tool may be provided around the machine tool; and

the use monitoring device may be configured to transmit the information on the usage of the machine tool inclusive of information on usage of the accessory instrument to the management device.

The accessory instrument includes, for example, a chuck, a soft jaw, a tool (including a tool holder), a throw-away tip, and a detachable measurement instrument. In some machining operations, the user wants to use the accessory instrument that can be used in the machine tool, in addition to the machine tool. With this configuration, the user can use the accessory instrument as necessary, and the machine tool manufacturer can charge the user a cost corresponding to usage of the accessory instrument.

In the present invention, the machine tool may have provided therein various sensors each detecting a status of the machine tool; and

the use monitoring device may be configured to transmit information obtained from the various sensors, as the information on the usage of the machine tool, to the management device.

Note that the sensors include, for example, an electric power meter, a motor load ammeter, an accelerometer, and a thermometer, and the information obtained from the sensors includes, for example, electric energy data, spindle motor load data, feed motor load data, vibration data of each machine tool part, and temperature data of each machine tool part. Collecting such information enables obtaining of data on a load status of the machine tool and data on performance of the machine tool against load; the data obtained can be utilized in development and improvement of a machine tool of the next version.

Further, in the present invention, the management device may be configured to analyze the information obtained from the various sensors received from the use monitoring device, determine whether the machine tool has an abnormality or whether the machine tool is predicted to fall into a state of having an abnormality, and, when it is confirmed that the machine tool has an abnormality or when the machine tool is predicted to fall into the state of having an abnormality, transmit a signal relating to the abnormality to the use monitoring device. With this configuration, the user can use the machine tool with a sense of security. Note that the expression “the machine tool is predicted to fall into a state of having an abnormality” means that the machine tool will fall into a state of having an abnormality in the near future, the near feature meaning, for example, a future determined by the number of days which allows the machine tool manufacturer to resolve the abnormality before the machine tool falls into the state of having the abnormality.

In the present invention, the use monitoring device may be configured to transmit data on an operational status obtained from the machine tool to the management device; and

the management device may be configured to accumulate the received data on the operational status, and analyze the accumulated data to store the data at least as production technology information.

The data on the operational status (operational information) includes, for example, cutting conditions (including a cutting speed, a feed speed, a workpiece material, and a tool material), tool life data, and data on spindle rotation speed, etc. Transmitting such operational information to the management device enables accumulation of a wide variety of production technology information in the management device, and analyzing, editing, and systematizing the accumulated production technology information as appropriate makes the production technology information versatile and highly reliable.

Further, in the present invention, the use monitoring device may be configured to execute a processing of requesting permission from the management device to use the production technology information stored in the management device; and

the management device may be configured to calculate the use fee for the machine tool according to use/non-use of the production technology information.

As described above, the production technology information is collected in the management device; therefore, versatile and highly reliable production technology information is accumulated in the management device. Therefore, the user can utilize the production technology information to more properly perform machining. On the other hand, the machine tool manufacturer can obtain commensurate profits by providing the accumulated production technology information to the user and charging the user the use fee according to use of the production technology information.

In the present invention, the machine tool may be disposed at a location available to an unspecified user;

the use monitoring device may be configured to execute a processing of requesting permission from the management device to use the machine tool, and when obtaining the permission from the management device, execute a processing of making the machine tool operational; and

the management device may be configured to, when receiving a signal requesting permission to use the machine tool from the use monitoring device, execute a processing of recognizing the user and execute a processing of judging permissibility and sending a reply to the use monitoring device.

With this machine tool management system, the machine tool is disposed at a location available to an unspecified user. Further, the use monitoring device executes a processing of requesting permission from the management device to use the machine tool, and when obtaining the permission from the management device, executes a processing of making the machine tool operational.

On the other hand, when receiving a signal requesting permission to use the machine tool from the use monitoring device, the management device executes a processing of recognizing the user and executes a processing of judging permissibility and sending a reply to the use monitoring device.

Accordingly, with this management system, the user can use the machine tool only when the user is recognized by the management device and permitted to use the machine tool. Therefore, it is possible to eliminate use by a user who has used the machine tool in an improper manner and use by a user who has not made proper settlement, which enables proper operation of the system and increased safety.

In the case where the machine tool is disposed at a location used by a specified user, the user's location is obvious and it is assumed that reliability of the user has been built; therefore, the above-described problem is unlikely to occur. In contrast, in the case where the machine tool is disposed at al location available to a number of unspecified users, it is not always true that reliability of the user has been built; therefore, the above-described configuration is effective particularly in such a case.

### Advantageous Effects of Invention

As described above, with the machine tool management system according to the present invention, the user does not have to purchase the machine tool and can perform necessary machining only by paying a use fee corresponding to usage of the machine tool. Therefore, even in the case where the amount of work the user has is not so large as to cause the machine tool to run at full capacity, the user can perform machining corresponding to the amount of work without installing a new machine tool; therefore, the user can accommodate demand. Further, paying a use fee corresponding to usage of the machine tool as described above allows the user to replace the existing machine tool with a state-of-the-art machine tool without making capital expenditure. Therefore, replacement of equipment is promoted even in the case where the user does not have stable demand or even in the case where there is a risk such as sudden fluctuation in demand.

On the other hand, since new demand is generated which does not require capital expenditure, the machine tool manufacturer can achieve a stable planned production that facilitates obtaining profits. Further, since the management system is a system using the Internet, the machine tool can be installed in any region. For example, the machine tool can be installed abroad, and, even in such a case where the machine tool is installed abroad, the charging processing can be executed efficiently.

### BRIEF DESCRIPTION OF DRAWINGS

FIG. 1 is a block diagram showing a schematic configuration of a machine tool management system according to an embodiment of the present invention;

FIG. 2 is a block diagram showing a configuration of a use monitoring device, a machine tool, and other components according to the embodiment;

FIG. 3 is a block diagram showing a configuration of a management device according to the embodiment; and

FIG. 4 is a flowchart showing a procedure for using the machine tool in the machine tool management system according to the embodiment.

### DESCRIPTION OF EMBODIMENTS

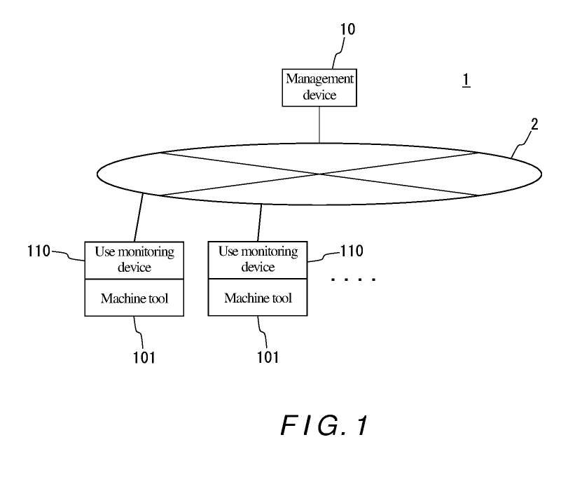

Hereinafter, a specific embodiment of the present invention will be described with reference to the drawings. FIG. 1 is a block diagram showing a schematic configuration of a machine tool management system (hereinafter, simply referred to as “management system”) according to the embodiment.

As shown in FIG. 1, the management system 1 according to this embodiment is composed of a management device 10 connected to Internet 2 and a plurality of machine tools 101 each having a use monitoring device 110 attached thereto, the use monitoring device 110 being connected to the Internet 2.

Each machine tool 101 is disposed at a location available to a specified user, e.g., in a machining plant owned by a specified user, or a location available to an unspecified user, e.g., in a building arranged by the machine tool manufacturer. The building arranged by the machine tool manufacturer is available to a number of unspecified users, and has a concept like “machine center”. The management device 10 is under management by the machine tool manufacturer; however, the management device 10 can be installed at any location. Hereinafter, each component is described in detail.

[Machine Tool]

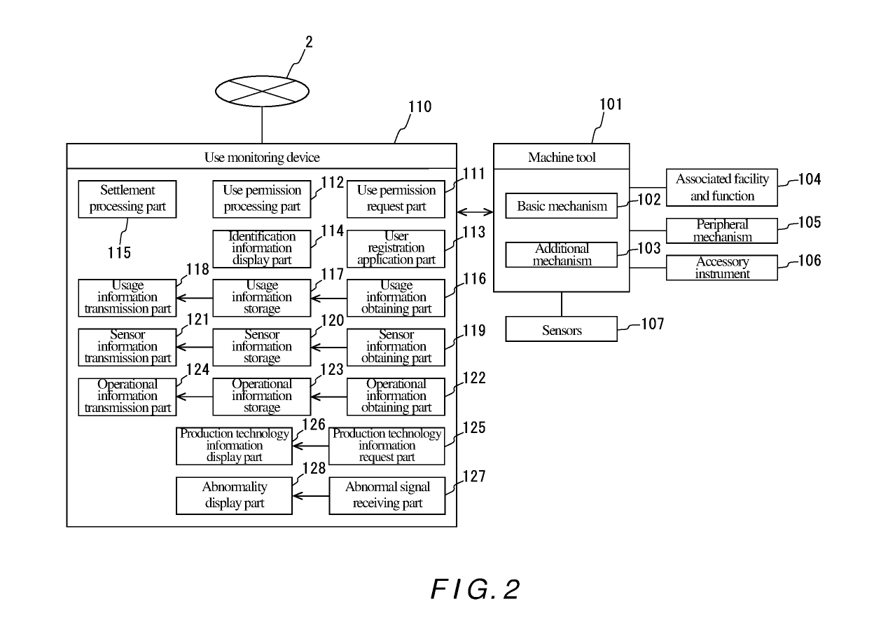

As shown in FIG. 2, each machine tool 101 includes a basic mechanism 102 and an additional mechanism 103. In addition, the machine tool 101 has provided therein associated facility and function (hereinafter referred to as “associated facility”) 104, a peripheral mechanism 105, and various sensors 107, and has provided therearound an accessory instrument 106. Note that the basic mechanism 102 and the additional mechanism 103 perform machining, and they are regarded as constituting a main mechanism.

The machine tool 101 can be of any type, examples of which include an NC lathe and a machining center, which are most common. In the case of an NC lathe, the basic mechanism 102 is a turning mechanism, and the additional mechanism 103 is, for example, one or more mechanisms selected from among a tailstock mechanism, a steady rest mechanism, a milling mechanism, second and subsequent tool rests, second and subsequent spindle mechanisms, and a coolant mechanism. In the case of a machining center, the basic mechanism 102 is a milling mechanism, and the additional mechanism 103 is, for example, one or more mechanisms selected from among a rotating shaft other than a tool spindle, a mechanism associated with a U-shaft of the tool spindle, a workpiece clamping mechanism, and a coolant mechanism.

The associated facility 104 is a facility or function incorporated in or attached to the machine tool 101, examples of which include an automatic programming apparatus, an interactive programming apparatus, a special cycle function, a tool measurement system, and a workpiece measurement system.

The peripheral mechanism 105 is a mechanism provided around the basic mechanism 102 and additional mechanism 103 (main mechanism) performing machining, examples of which include a robot and a workpiece loading/unloading apparatus (including a loader and the like). The accessory instrument 106 is an instrument to be used in machining performed with the machine tool 101, which is disposed around the machine tool 101. The accessory instrument 106 includes, for example, a chuck, a soft jaw, a tool (including a tool holder), a throw-away tip, and a detachable measurement instrument.

Further, the machine tool 101 has attached thereto the sensors 107. The sensors 107 include, for example, an electric power meter, a motor load ammeter, an accelerometer, and a thermometer. The sensors 107 provide, for example, information such as electric energy data, spindle motor load data, feed motor load data, vibration data of each machine tool part, and temperature data of each machine tool part.

[Use Monitoring Device]

As shown in FIG. 2, each use monitoring device 110 consists of functional units: a use permission request part 111, a use permission processing part 112, a user registration application part 113, an identification information display part 114, a settlement processing part 115, a usage information obtaining part 116, a usage information storage 117, a usage information transmission part 118, a sensor information obtaining part 119, a sensor information storage 120, a sensor information transmission part 121, an operational information obtaining part 122, an operational information storage 123, an operational information transmission part 124, a production technology information request part 125, a production technology information display part 126, an abnormal signal receiving part 127, and an abnormality display part 128.

Note that the use monitoring device 110 is composed of a typical computer including a CPU, an ROM, and an RAM, as well as an input device, such as a keyboard or the like, and a display. The functions of the use permission request part 111, use permission processing part 112, user registration application part 113, identification information display part 114, settlement processing part 115, usage information obtaining part 116, usage information transmission part 118, sensor information obtaining part 119, sensor information transmission part 121, operational information obtaining part 122, operational information transmission part 124, production technology information request part 125, production technology information display part 126, abnormal signal receiving part 127, and abnormality display part 128 are each implemented by appropriate software. The usage information storage 117, the sensor information storage 120, and the operational information storage 123 are composed of an appropriate storage medium, such as an RAM or the like.

Once a user inputs his or her identification information and particulars of usage of the additional mechanism 103, associated facility 104, peripheral mechanism 105, and accessory instrument 106 of the machine tool 101 to be used, the use permission request part 111 transmits information on the input identification information and usage particulars to the management device 10 and requests permission from the management device 10 to use the machine tool 101. Upon receiving a use permitting signal from the management device 10, the use permission processing part 112 transmits a use permission signal to a controller of the machine tool 101. Upon receiving the use permission signal, the controller brings an operation panel in a non-operational state (locked state) into an operational state (unlocked state), thereby enabling operation of the machine tool 101. In contrast, upon receiving a not-permitting signal from the management device 10, the use permission processing part 112 displays on the display the receiving of the not-permitting signal. In this case, the machine tool 101 is maintained at the non-operational state (locked state).

Note that in a case where the user has not been assigned identification information, the user registration application part 113 executes a processing. That is, once the user inputs information needed for registration, the user registration application part 113 transmits the input registration information to the management device 10. The transmitted registration information is registered by a user registration processing part 11, which is described in detail later, and identification information for the user is transmitted from the management device 10 to the use monitoring device 110. The received identification information is displayed on the display through a processing by the identification information display part 114. The registration information includes, for example, personal information, such as the user's address and name, and information needed for electronic settlement (e.g., credit card information, a bank account number available for withdrawal, or the like.). Further, in a case where the machine tool 101 is installed at a location used by a specified user, the user's identification information in association with information specific to the machine tool 101 or information specific to the user monitoring device 110 is transmitted to the management device 10 and registered by the user registration processing part 11.

The usage information obtaining part 116 obtains usage information of the controller of the machine tool 101, associated facility 104, peripheral mechanism 105, and sensors 107 from them. Further, the usage information obtaining part 116 obtains information on the usage particulars, as usage information, from the use permission request part 111, obtains data on an operational status (operational information) of the controller of the machine tool 101, etc., as usage information, from them, and obtains, as usage information, the status of utilization of production technology information provided to the production technology information request part 125, which is described in detail later, by the management device 10. The usage information forms the basis of calculation for charging the user a commensurate cost for the use of the machine tool 101, the usage information including, for example, an operating time and a load status of the machine tool 101, use/non-use and operating times of the associated facility 104 and peripheral mechanism 105, use/non-use of the accessory instrument 106, and the status of utilization of the production technology information provided by the management device 10.

More specifically, in a case where the controller of the machine tool 101 has equipped therewith an automatic programming apparatus or an interactive programming apparatus as the associated facility 104, when the user uses the automatic programming apparatus to generate an NC program or uses the interactive programming apparatus to generate an interactive program, the usage information obtaining part 116 obtains information on the use of the programming apparatus as usage information. Further, in a case where the controller of the machine tool 101 has equipped therewith special cycle functions, when the user selects any of the special cycle functions (e.g., when the user presses a button or icon for the special cycle function on a display of the controller), the usage information obtaining part 116 obtains information on the selection of the special cycle function as usage information. Furthermore, in a case where the machine tool 101 has equipped therewith a tool measurement system or a workpiece measurement system, when the user uses the measurement system, the usage information obtaining part 116 obtains information on the use of the measurement system as usage information.

Further, in the case where the machine tool 101 includes the additional mechanism 103, the usage information obtaining part 116 obtains use/non-use of the additional mechanism 103 as usage information based on NC codes of an NC program analyzed in the controller of the machine tool 101. Furthermore, in a case where a workpiece loading/unloading apparatus, such as a gantry loader, or a robot is provided as the peripheral mechanism 105, the usage information obtaining part 116 detects use/non-use of the peripheral mechanism 105 based on signals transmitted between the controller of the machine tool 101 and the peripheral mechanism 105 during operation, and obtains the detected use/non-use as usage information. Furthermore, in a case where a dispenser containing a chuck, a soft jaw, various tools, and the like is provided as the accessory instrument 106, the usage information obtaining part 116 detects an operational signal which is obtained from the dispenser when the user picks a necessary instrument from the dispenser, and obtains the detected operational signal as usage information.

Further, the usage information obtained from the sensors 107 includes, for example, electric energy data, spindle motor load data, and feed motor load data. Further, the above-mentioned operational information includes information obtained through analysis of an NC program, e.g., rotational speed information (S codes) and feed information (F codes), as well as miscellaneous function information (M codes), such as on/off of hydraulic pressure for steady rest and the like.

The usage information obtained by the usage information obtaining part 116 is stored into the usage information storage 117. The usage information stored in the usage information storage 117 is transmitted to the management device 10 by the usage information transmission part 118 at the point of time when the user ends the use of the machine tool 101.

In parallel with the usage information obtaining part 116, the sensor information obtaining part 119 obtains output data from the sensors 107 periodically or non-periodically and stores the obtained data into the sensor information storage 120. The data obtained from the sensors 107 includes, for example, electric energy data, spindle motor load data, feed motor load data, vibration data of each machine tool part and temperature data of each machine tool part. The data (sensor information) stored in the sensor information storage 120 is transmitted to the management device 10 by the sensor information transmission part 121 periodically or non-periodically until the user ends the use of the machine tool 101.

In parallel with the usage information obtaining part 116, the operational information obtaining part 122 obtains data on the operational status (operational information) of the controller of the machine tool 101, etc. from them, and stores the obtained data into the operational information storage 123. The operational information includes, for example, data on cutting conditions (including a cutting speed, a feed speed, a workpiece material, and a tool material) for a machining operation performed in the machine tool 101, tool life data, and data such as a spindle rotation speed. The operational information stored in the operational information storage 123 is transmitted to the management device 10 by the operational information transmission part 124 at the point of time when the user ends the use of the machine tool 101.

In accordance with an input made by the user, the production technology information request part 125 requests the management device 10 to provide production technology information, to obtain necessary production technology information form the management device 10. The obtained production technology information is displayed on the display through the production technology information display part 126.

The abnormal signal receiving part 127 receives an abnormal signal transmitted from the management device 10. The received abnormal signal is displayed on the display through the abnormality display part 128.

The settlement processing part 115 makes an electronic settlement (e.g., a known credit card settlement) through the Internet 2 for a use fee charged by the management device 10, by executing a processing in cooperation with the management device 10.

[Management Device]

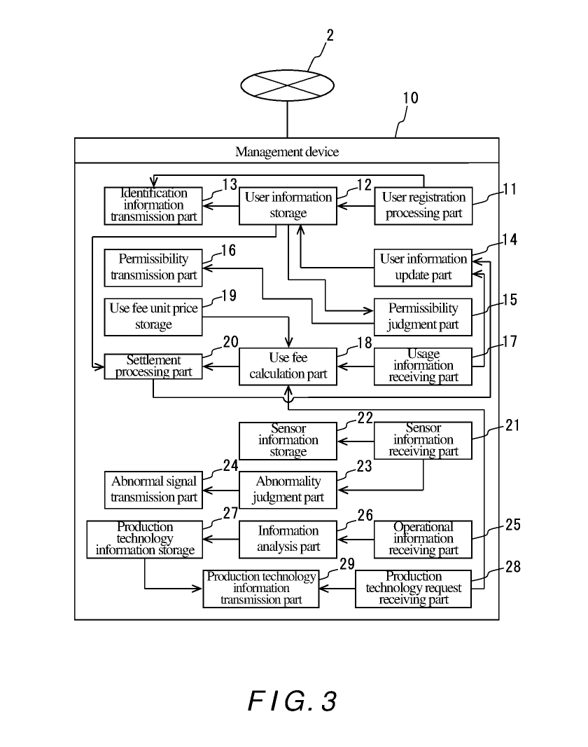

As shown in FIG. 3, the management device 10 consists of functional units: a user registration processing part 11, a user information storage 12, an identification information transmission part 13, an user information update part 114, a permissibility judgment part 15, a permissibility transmission part 16, a usage information receiving part 17, a use fee calculation part 18, a use fee unit price storage 19, a settlement processing part 20, a sensor information receiving part 21, a sensor information storage 22, an abnormality judgment part 23, an abnormal signal transmission part 24, an operational information receiving part 25, an information analysis part 26, a production technology information storage 27, a production technology request receiving part 28, and a production technology information transmission part 29.

Note that the management device 10 is also composed of a typical computer including a CPU, an ROM, and an RAM, as well as an input device, such as a keyboard or the like, and a display. The functions of the user registration processing part 11, identification information transmission part 13, user information update part 114, permissibility judgment part 15, permissibility transmission part 16, usage information receiving part 17, use fee calculation part 18, settlement processing part 20, sensor information receiving part 21, abnormality judgment part 23, abnormal signal transmission part 24, operational information receiving part 25, information analysis part 26, production technology request receiving part 28, and production technology information transmission part 29 are each implemented by appropriate software. The user information storage 12, the use fee unit price storage 19, the sensor information storage 22, and the production technology information storage 27 are composed of an appropriate storage medium, such as an RAM or the like.

The user registration processing part 11 is a functional unit that accepts a registration application from the user registration application part 113 of each use monitoring device 110 and executes a registration processing for the user. The user registration processing part 11 accepts registration information transmitted from the user registration application part 113 and stores the accepted registration information into the user information storage 12. Further, the user registration processing part 11 generates identification information which is specific to the user, assigns the user the identification information, and stores the assigned identification information into the user information storage 12. Note that, as described above, in the case where the machine tool 101 is installed at a location used by a specified user, the user's identification information in association with the information specific to the machine tool 101 or the information specific to the use monitoring device 110 is stored into the user information storage 12.

The assigned identification information is transmitted to the use monitoring device 110 by the identification information transmission part 13. The user information storage 12 is configured to store usage history and the status of settlement for each registered user. Based on information from the usage information receiving part 17 and from the settlement processing part 20, as well as information input externally in some cases, the information stored in the user information storage 12 is updated by the user information update part 14.

The permissibility judgment part 15 receives a signal requesting use permission transmitted from the use permission processing part 111 of each use monitoring device 110, which is described in detail later, and judges whether the use permission requesting user can be permitted to use the machine tool 101. Specifically, the permissibility judgment part 15 checks the usage history and settlement status of the user by referring to the user information storage 12. When an improper usage is found in the usage history and/or it is confirmed that a settlement remains undone, the permissibility judgment part 15 makes a judgment that the user cannot be permitted to use the machine tool 101. Otherwise, the permissibility judgment part 15 makes a judgment that the user can be permitted to use the machine tool 101.

Note that the permissibility judgment part 15 may be configured such that, in the case where the machine tool 101 is installed at a location used by a specified user, the use permission requesting user is not permitted to use the machine tool 101 if the user is not the user corresponding to the machine tool 101. However, permitting the use permission requesting user to use the machine tool 101 even in such a case increases availability of the machine tool 101, which results in increase in the machine tool manufacturer's profits. Therefore, where there is no other problem, the permissibility judgment part 15 may be configured to permit many users to use the machine tool 101.

After the permissibility judgment part 15 makes a judgment about permissibility for the user in the above-described manner, the result of the judgment is transmitted to the use monitoring device 110 by the permissibility transmission part 16.

The usage information receiving part 17 is a functional unit that receives the usage information transmitted from the usage information transmission part 18 of each use monitoring device 110, and forwards the received usage information to the use fee calculation part 18.

The use fee calculation part 18 calculates a use fee for the user by referring to a use fee unit price for each item stored in the use fee unit price storage 19 based on the received usage information, and forwards the calculated use fee to the settlement processing part 20. For example, the use fee calculation part 18 calculates a basic use fee for use of the machine tool 101 by multiplying the operating of use by the unit price therefor, calculates an additional use fee based on the load status of the machine tool 101 and use/non-use of the associated facility 104, peripheral mechanism 105, accessory instrument 106, and production technology information, and then calculates a total use fee by adding up the basic use fee and the additional use fee. Note that, in this case, the unit prices may be varied according to the frequency of use of the associated facility or the like 104, peripheral mechanism 105, and accessory instrument 106. For example, a lower unit price is applied to a greater number of times of use, or a lower unit price is applied to a longer operating time. Further, points may be provided to the user according to use so that the user can use some functions or the like with no charge when a certain number of points is reached.

The settlement processing part 20 transmits the use fee calculated by the use fee calculation part 18 to the use monitoring device 110, and makes electronic settlement of the use fee in cooperation with the settlement processing part 115 of the use monitoring device 110. The electronic settlement has been described above.

The sensor information receiving part 21 is a functional unit that receives the sensor information transmitted from the sensor information transmission part 121 of each use monitoring device 110. The sensor information receiving part 21 stores the received sensor information into the sensor information storage 22 and forwards the received sensor information to the abnormality judgment part 23.

The abnormality judgment part 23 analyzes the received sensor information and judges whether the machine tool 101 has any abnormality. When confirming that the machine tool 101 has an abnormality, the abnormality judgment part 23 transmits an abnormal signal relating to the abnormality to the use monitoring device 110 through the abnormal signal transmission part 24.

The operational information receiving part 25 is a functional unit that receives the operational information transmitted from the operational information transmission part 124 of each use monitoring device 110, and forwards the received operational information to the information analysis part 26. The information analysis part 26 analyzes the received operational information to extract production technology information, edits and systematizes the extracted production technology information, and stores the edited and systematized production technology information into the production technology information storage 27.

The production technology request receiving part 28 receives the request signal from the production technology information request part 125 of each use monitoring device 110 and forwards the received request signal to the production technology information transmission part 29. The production technology information transmission part 29 refers to the production technology information stored in the production technology information storage 27, reads out the production technology information corresponding to the received request signal, and transmits the read-out production technology information to the use monitoring device 110.

In the management system 1 according to this embodiment having the above-described configuration, use of a machine tool 101 by a user and charging according to usage of the machine tool 101 are executed in the following procedure.

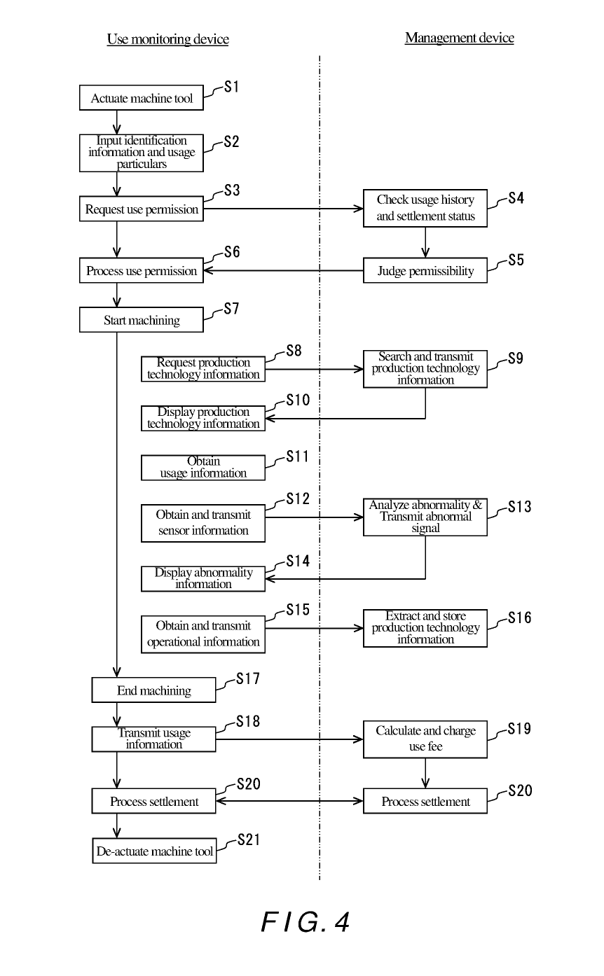

As sown in FIG. 4, first, once a user turns on a machine tool 101 to be used that is connected to the Internet 2, the machine tool 101 and the corresponding use monitoring device 110 are actuated (step S1). Note that, at this moment, the user cannot operate the machine tool 101 yet.

Subsequently, once the user inputs, into the use monitoring device 110, his or her identification information as well as particulars (usage particulars) of the additional mechanism 103, associated facility 104, peripheral mechanism 105, and accessory instrument 106 to be used (step S2), information on the input identification information and use particulars together with a signal requesting use permission are transmitted from the use permission request part 111 to the management device 10 (step S3), and the transmitted information and signal are received by the permissibility judgment part 15.

The permissibility judgment part 15 refers to the data stored in the user information storage 12 based on the received information on the identification information and usage particulars to check the usage history and settlement status of the user corresponding to the transmitted identification information (step S4). In the case where an improper use is found in the usage history and/or it is confirmed that a settlement remains undone, the permissibility judgment part 15 makes a judgment that the user cannot be permitted to use the machine tool 101. Otherwise, the permissibility judgment part 15 makes a judgment that the user can be permitted to use the machine tool 101. Thereafter, the permissibility judgment part 15 transmits the result of the judgment about permissibility of use of the machine tool 101 to the use monitoring device 110 through the permissibility transmission part 16 (step S5).

Note that, in the case where the user has not been registered, as described above, the user registration application part 113 of the use monitoring device 110 and the user registration processing part 11 of the management device 10 execute the processing to assign the user identification information and register the user.

Upon receiving the result of the judgment about the permissibility from the permissibility transmission part 16, in the case where the result is “permissible”, the use permission processing part 112 of the use monitoring device 110 transmits a use permission signal to the controller of the machine tool 101 (step S6). Upon receiving the use permission signal, the controller brings the operation panel in the non-operational state (locked state) into the operational state (unlocked state). Thereby, the machine tool 101 becomes ready for operation. In contrast, in the case of receiving the “impermissible” signal from the management device 10, the use permission processing part 112 displays on the display the receiving of the “impermissible” signal.

Thereafter, in the case where the use of the machine tool 101 to be used is permitted, the user uses the machine tool 101 to perform necessary machining (step S7). Note that the user can utilize the production technology information accumulated in the production technology information storage 27 of the management device 10 through the production technology information request part 125 of the use monitoring device 110. When the user requests necessary production technology information through the production technology information request part 125 (step S8), the request is received by the production technology request receiving part 28 of the management device 10, which causes the production technology information transmission part 29 to search the production technology information accumulated in the production technology information storage 27 and transmit the requested production technology information to the use monitoring device 110 (step S9). In the use monitoring device 110, the transmitted production technology information is displayed on the display through the production technology information display part 126 (step S10). Thus, the user can utilize the production technology information he or she requested.

While the machining is being performed, the usage information obtaining part 116 of the use monitoring device 110 obtains usage information of the controller of the machine tool 101, sensors 107, associated facility 104, and peripheral mechanism 105 from them, obtains the information on the usage particulars as usage information from the use permission processing part 111, and obtains, as usage information, the status of utilization of the production technology information obtained from the management device 10 through the production technology information request part 25, and the obtained usage information is stored into the usage information storage 117 (step S11).

Further, while the machining is being performed, the sensor information obtaining part 119 of the use monitoring device 110 also stores data (sensor information) output from the sensors 107 into the sensor information storage 120 periodically or non-periodically, and the stored sensor information is transmitted to the management device 10 periodically or non-periodically by the sensor information transmission part 121 (step S12).

Furthermore, while the machining is being performed, the operational information obtaining part 122 also obtains data on the operational status (operational information) of the controller of the machine tool 101, etc. from them periodically or non-periodically, and stores the obtained data into the operational information storage 123, and the stored operational information is transmitted to the management device 10 periodically or non-periodically by the operational information transmission part 124 (step S15).

On the other hand, in the management device 10, the sensor information receiving part 21 receives the sensor information transmitted from the use monitoring device 110 and stores the received sensor information into the sensor information storage 22, and the abnormality judgment part 23 analyzes the received data and judges whether the machine tool 101 has any abnormality. In the case where it is confirmed that the machine tool 101 has an abnormality, an abnormal signal relating to the abnormality is transmitted to the use monitoring device 110 through the abnormal signal transmission part 24 (step S13). Once the abnormal signal is transmitted from the management device 10, the abnormal signal receiving part 127 of the use monitoring device 110 receives the abnormal signal and displays the received abnormal signal on the display through the abnormality display part 128 (step S14).

Further, the operational information receiving part 25 receives the operational information transmitted from the use monitoring device 110, and the information analysis part 26 analyzes the received operational information to extract production technology information, edits and systematizes the extracted production technology information, and then stores the edited and systematized production technology information into the production technology information storage 27 (step S16).

When the user ends the machining operation (step S17), the usage information stored in the usage information storage 117 of the use monitoring device 110 is transmitted to the management device 10 by the usage information transmission part 118 (step S18).

Once the transmitted usage information is received by the usage information receiving part 17 of the management device 10, the use fee calculation part 18 calculates a use fee for the user by referring to the use fee unit price for each item stored in the use fee unit price storage 19 based on the received usage information, and forwards the calculated use fee to the settlement processing part 20 (step S19).

Thereafter, the settlement processing part 20 transmits the calculate use fee to the use monitoring device 110, and makes electronic settlement of the use fee in cooperation with the settlement processing part 115 of the use monitoring device 110 (step S20). After the settlement is finished, the machine tool 101 is de-actuated, that is, brought into the locked state.

As described in detail above, with the management system 1 according to this embodiment, the user does not have to purchase the machine tool 101; the user can perform necessary machining only by paying a use fee corresponding to usage of the machine tool 101. Therefore, even in the case where the amount of work the user has is not so large as to cause the machine tool 101 to run at full capacity, the user can perform machining corresponding to the amount of work without installing a new machine tool 101; therefore, the user can accommodate demand. Further, paying a use fee corresponding to usage of the machine tool 101 as described above allows the user to replace the existing machine tool with a state-of-the-art machine tool 101 without making capital expenditure. Therefore, replacement of equipment is promoted even in the case where the user does not have stable demand or even in the case where there is a risk such as sudden fluctuation in demand.

On the other hand, since new demand is generated which does not require capital expenditure, the machine tool manufacturer can realize a stable planned production that facilitates obtaining profits. Further, since the management system 1 is a system using the Internet 2, the machine tool 101 can be installed in any region. For example, the machine tool 101 can be installed abroad, and, even in such a case where the machine tool 101 is installed abroad, the charging processing can be executed efficiently.

Further, in this embodiment, since the machine tool 101 including the additional mechanism 103 is employed and the associated facility 104, the peripheral mechanism 105, and the accessory instrument 106 are also provided, the management system 1 can satisfy user's various requests and demands, which results in increase in availability of the machine tool 101.

Further, since the management system 1 is configured such that the sensor information obtained from the sensors 107 provided in the machine tool 101 is accumulated in the sensor information storage 22 of the management device 10, the load status of the machine tool 101 and performance of the machine tool 101 against load can be evaluated by analyzing the obtained data, and evaluation results obtained can be utilized in development and improvement of a machine tool of the next version.

Further, the management system 1 according to this embodiment is configured such that the information obtained from the sensors 107 provided in the machine tool 101 is analyzed by the abnormality judgment part 23 of the management device 10, and when a judgment is made that the machine tool 101 has an abnormality, an abnormal signal is transmitted from the management device 10 to the use monitoring device 110 and displayed on the display of the use monitoring device 110. Therefore, when the machine tool 101 to be used has an abnormality, the user can recognize the abnormality instantaneously. Therefore, the user can use the machine tool 101 with a sense of security.

Further, the management system 1 according to this embodiment is configured such that the operational information of the machine tool 101 is collected from the use monitoring device 110, and the collected operational information is analyzed by the information analysis part 26 to extract production technology information, and the extracted production technology information is edited and systematized, and then accumulated in the production technology information storage 27. Therefore, versatile and highly reliable production technology information can be accumulated in the production technology information storage 27. Further, since the user can utilize the thus-accumulated production technology information, the user can more properly perform machining by utilizing the production technology information. On the other hand, the machine tool manufacturer can obtain commensurate profits by providing the accumulated production technology information to the user and charging the user the use fee according to use of the production technology information.

Further, the management system 1 according to this embodiment is configured such that the user is not permitted to use the machine tool 101 when the permissibility judgment part 15 of the management device 10 confirms an improper use in the usage history of the user and/or confirms that a settlement remains undone; therefore, proper operation of the system and increased safety can be achieved.

Hereinbefore, one embodiment of the present invention has been described. However, the present invention is not limited to the above embodiment and can be implemented in other modes.

For example, the above embodiment is configured such that user registration is executed. However, the present invention is not necessarily limited to such a configuration. As long as the processing of charging the user can be executed without fail and the settlement of the charge can be executed without fail, user registration does not have to be executed.

In the above embodiment, taking into consideration convenience for the user, the machine tool 101 including the additional mechanism is employed and the associated facility 104, the peripheral mechanism 105, the accessory instrument 106, and the sensors 107 are provided. However, these components are only additional components, the machine tool 101 only has to have the basic mechanism 102 and have a configuration which is able to charge the user the use fee according to usage of the machine tool 101.

Further, the above embodiment has a configuration in which the use monitoring device 110 is provided separately from the machine tool 101. However, the present invention is not limited to such a configuration, and a configuration may be employed in which the use monitoring device 110 is incorporated in the controller of the machine tool 101.

### REFERENCE SIGNS LIST

1 Machine tool management system

2 Internet

10 Management device

11 User registration processing part

12 User information storage

13 Identification information transmission part

14 User information update part

15 Permissibility judgment part

16 Permissibility transmission part

17 Usage information receiving part

18 Use fee calculation part

19 Use fee unit price storage

20 Settlement processing part

21 Sensor information receiving part

22 Sensor information storage

23 Abnormality judgment part

24 Abnormal signal transmission part

25 Operational information receiving part

26 Information analysis part

27 Production technology information storage

28 Production technology request receiving part

29 Production technology information transmission part

101 Machine tool

102 Basic mechanism

103 Additional mechanism

104 Associated facility and function

105 Peripheral mechanism

106 Accessory instrument

107 Sensors

110 Use monitoring device

111 Use permission request part

112 Use permission processing part

113 User registration application part

114 Identification information display part

115 Settlement processing part

116 Usage information obtaining part

117 Usage information storage

118 Usage information transmission part

119 Sensor information obtaining part

120 Sensor information storage

121 Sensor information transmission part

122 Operational information obtaining part

123 Operational information storage

124 Operational information transmission part

125 Production technology information request part

126 Production technology information display part

127 Abnormal signal receiving part

128 Abnormality display part

1. A machine tool management system, comprising:
at least one machine tool having attached thereto a use monitoring device having a communication function for connecting to Internet, the machine tool being disposed at a location available to a specified or unspecified user; and
a management device connecting to the Internet and communicating with the use monitoring device,
the use monitoring device being configured to transmit information on usage of the machine tool to the management device; and
the management device being configured to calculate, as a use fee, a cost corresponding to the usage of the machine tool received from the use monitoring device, and then execute a processing of charging the calculated use fee to the user.

2. The machine tool management system according to claim 1, wherein the management device is configured to make settlement of the use fee charged to the user, by executing a processing in cooperation with the use monitoring device.

3. The machine tool management system according to claim 1, wherein:
the use monitoring device is configured to execute a processing of registering the user in the management device; and
the management device is configured to execute a processing of transmitting identification information for the registered user to the use monitoring device.

4. The machine tool management system according to claim 1, wherein:
the machine tool has provided therein associated facility and function to be used in machining performed with the machine tool; and
the use monitoring device is configured to transmit the information on the usage of the machine tool inclusive of information on usage of the associated facility and function to the management device.

5. The machine tool management system according to claim 1, wherein:
the machine tool includes a turning mechanism as a basic mechanism and includes, as an additional mechanism, one or more mechanisms selected from among a tailstock mechanism, a steady rest mechanism, a milling mechanism, second and subsequent tool rests, second and subsequent spindle mechanisms, and a coolant mechanism; and
the use monitoring device is configured to transmit the information on the usage of the machine tool inclusive of information on usage of the additional mechanism to the management device.

6. The machine tool management system according to claim 1, characterized in that wherein:
the machine tool includes a milling mechanism as a basic mechanism and includes, as an additional mechanism, one or more mechanisms selected from among a rotating shaft other than a tool spindle, a mechanism associated with a U-shaft of the tool spindle, a workpiece clamping mechanism, and a coolant mechanism; and
the use monitoring device is configured to transmit the information on the usage of the machine tool inclusive of information on usage of the additional mechanism to the management device.

7. The machine tool management system according to claim 1, wherein:
the machine tool includes a main mechanism performing machining, and a peripheral mechanism provided around the main mechanism; and
the use monitoring device is configured to transmit the information on the usage of the machine tool inclusive of information on usage of the peripheral mechanism to the management device.

8. The machine tool management system according to claim 1, wherein:
an accessory instrument to be used in machining performed with the machine tool is provided around the machine tool; and
the use monitoring device is configured to transmit the information on the usage of the machine tool inclusive of information on usage of the accessory instrument to the management device.

9. The machine tool management system according to claim 1, wherein:
the machine tool has provided therein various sensors each detecting a status of the machine tool; and
the use monitoring device is configured to transmit information obtained from the various sensors, as the information on the usage of the machine tool, to the management device.

10. The machine tool management system according to claim 9, wherein the management device is configured to analyze the information obtained from the various sensors received from the use monitoring device, determine whether the machine tool has an abnormality or whether the machine tool is predicted to fall into a state of having an abnormality, and when it is confirmed that the machine tool has an abnormality or when the machine tool is predicted to fall into the state of having an abnormality, transmit a signal relating to the abnormality to the use monitoring device.

11. The machine tool management system according to claim 1, wherein:
the use monitoring device is configured to transmit data on an operational status obtained from the machine tool to the management device; and
the management device is configured to accumulate the received data on the operational status, and analyze the accumulated data to store the data at least as production technology information.

12. The machine tool management system according to claim 11, wherein:
the use monitoring device is configured to execute a processing of requesting permission from the management device to use the production technology information stored in the management device; and
the management device is configured to calculate the use fee for the machine tool according to use/non-use of the production technology information.

13. The machine tool management system according to claim 1, wherein:
the machine tool is disposed at a location available to an unspecified user;
the use monitoring device is further configured to execute a processing of requesting permission from the management device to use the machine tool, and when obtaining the permission from the management device, execute a processing of making the machine tool operational; and
the management device is further configured to, when receiving a signal requesting permission to use the machine tool from the use monitoring device, execute a processing of recognizing the user and execute a processing of judging permissibility and sending a reply to the use monitoring device.
